(19) United States
(12) Patent Application Publication
(10) Pub. No.: US 2005/0121859 A1
(43) Pub. Date: Jun. 9, 2005

(54) Gasket of non-rounded shape with installation aids

(76) Inventors: Francis Seidel, Houston, TX (US); Richard Davis, Montgomery, TX (US); Dan Reid, Kingwood, TX (US)

Correspondence Address: John M. Harrington;Kilpatrick Stockton LLP, 1001 West Fourth Street, Winston-Salem, NC, 27101, US

(21) Appl. No.: 11/005,639

(22) Filed: Dec. 6, 2004

Related U.S. Application Data
(60) Provisional application No. 60/527,228, filed on Dec. 5, 2003.

(51) Int. Cl. F16J 3/00

(52) U.S. Cl. 277/628

(57) ABSTRACT

A gasket assembly is comprising a substantially flat annular stainless steel gasket core having two partially profiled faces and defining an aperture therethrough, said partially profiled faces comprising a radially spaced alternating peak and groove configuration defined by peak angles of approximately 90°, and four installation tabs secured to an outer periphery of said gasket core formed of a ductile material, wherein said gasket core comprises a gasketing material is disposed upon the profiled faces.

### CROSS REFERENCE TO RELATED APPLICATIONS

The present application claims priority under 35 U.S.C. § 119(e) from U.S. Provisional Patent Application Ser. No. 60/527,228 filed Dec. 5, 2003, entitled “Gasket of Non-Rounded Shape With Installation Aids”, the disclosure of which is incorporated herein by reference.

### FIELD OF THE INVENTION

The present invention relates to gaskets for sealing junctures, such as opposing fluid sealing flange surfaces. More particularly, the present invention relates to gaskets for sealing non-round openings.

### BACKGROUND OF THE INVENTION

Large industrial processes such as petroleum or chemical processing plants, as well as large storage vessels, have high pressure tanks and reaction vessels which must be accessible by maintenance personnel. Large ports called manways are used to provide such access. These ports must be sealable to prevent leakage of the tank's contents while the tank is in use. These ports often have an oval, elliptical, or other non-round profile. This non-round configuration makes sealing by way of conventional gaskets difficult. Other non-round sealing applications would also benefit from specialized sealing devices.

Several types of gaskets for sealing the juncture between a manway, or flange and a vessel are well known in the art. For example, highly compressible gaskets such as those described in U.S. Pat. Nos. 4,900,629 or 4,859,526 (herein incorporated by reference) comprise a gasket material formed in sheets and cut to fit the opening to be sealed. Further, U.S. Pat. No. 5,421,594 (herein incorporated by reference) comprises a corrugated metal gasket with a soft gasket facing disposed thereon. One substantial limitation of this design is the inability of the gasket to withstand high internal pressures. These gaskets have been shown to fail at internal pressures of approximately 2,000 psi. This failure occurs in part because the gasket material does not sufficiently mechanically bond to the metal substrate, and therefore, has a limited amount of shear resistance to overcome high internal system pressures.

Another common gasket design that addresses this high-pressure requirement is the spiral wound gasket, such as the gasket of U.S. Pat. No. 5,964,468 (herein incorporated by reference), wherein a thin metal strip is wound around itself with strips of filler material inserted between the windings. A further gasket design is the Kammprofile gasket in which sealing elements are affixed to either side of a rigid metal support ring with profiled faces. This design overcomes the high-pressure limitation of the prior art through the use of a serrated surface that is formed into the metal substrate. The metal core is of a thicker gauge than the corrugated gaskets, and the forming process results in a more pronounced surface texture. The serrated surface provides significant mechanical resistance to the shearing of the soft gasket material as it is deformed into the serrations by the compressive forces applied by the flanges.

While these gasket types are effective in many sealing operations, particular problems arise when the gaskets are non-round in shape. For example, in pressure vessels, the door or cover is often an oval or elliptical shape requiring a similarly shaped gasket. Prior art gaskets adapted to have such a shape often function differently than when they are perfectly round. Unexpected or irregular deformation of the gasket, or improper alignment of the gasket with the aperture, affects the sealing ability of the gasket. Further, non-round gaskets constructed by welding or gluing several pieces together tend to break or deform irregularly at the joints.

Spiral wound gaskets having an oval shape are one of the most common designs used in non-round boiler manway connections. Although the spiral wound design is acceptable for high pressure applications, the inner most windings can spread radially inwards. One stop gap measure is to incorporate a solid metal inner ring in these gaskets to preclude this. However, there remains the problem of non-uniform deformation of the winding when the seal is compressed. This problem is further magnified by the fact that the spiral wound gasket requires a high unit stress to effect a seal, and this loading can be only available during high pressure operations. As such, during periods of low load, the effectiveness of the seal can be less than adequate.

Thus, there is a need for a gasket of non-round shape which can withstand high internal pressures while deforming in a uniform manner. Further there is a need for such a gasket which can provide the aforementioned advantages while requiring a low stress to seal. It is to these perceived needs that the present invention is directed.

### SUMMARY OF THE INVENTION

In a first aspect of the present invention, a gasket assembly is provided comprising an annular gasket core having two faces and defining an aperture therethrough, wherein at least one of the two faces has a profiled configuration along at least a portion of said face, at least one installation tab secured to an outer periphery of said gasket core, and gasketing material disposed upon the at least one profiled face.

In a preferred embodiment of the present invention, both faces of the gasket core are profiled and the profiling comprises a series of radially spaced concentric peaks separated by grooves formed into the core material. In one embodiment of the present invention, the profiling extends across less than the entire face of the gasket core and the gasketing material is disposed upon a portion of the gasket core face coextensive with said profiling. In an alternate embodiment of the present invention, the profiling extends across the entire radially face of the gasket core.

In a further embodiment of the present invention, the at least one installation tab comprises a bendable material. In another embodiment the at least one installation tab is welded to the gasket core. In a still further embodiment of the present invention, the at least one installation tab comprises four installation tabs.

In one embodiment of the present invention the gasketing material comprises expanded graphite. In another embodiment of the present invention , the gasketing material comprises a fluorocarbon polymer. In a still further embodiment of the present invention, the gasketing material comprises a fluorocarbon polymer with a graphite filler. In alternate embodiments of the present invention, the gasketing material is adhered to the gasket face with an adhesive, preferably a spray adhesive or alternately a pressure sensitive adhesive.

In a further aspect of the present invention, a gasket assembly is provided comprising a substantially flat annular gasket core having two profiled faces and defining an aperture therethrough, said profiled faces comprising an alternating peak and groove configuration defined by angles of approximately 90°, and at least one installation tab secured to an outer periphery of said gasket core, wherein said gasket core comprises a metallic material and gasketing material is disposed upon the profiled faces.

In yet another aspect of the present invention, a gasket assembly is provided comprising a substantially flat annular stainless steel gasket core having two partially profiled faces and defining an aperture therethrough, said partially profiled faces comprising a radially spaced alternating peak and groove configuration defined by peak angles of approximately 90°, and four installation tabs secured to an outer periphery of said gasket core formed of a ductile material, wherein said gasket core comprises a gasketing material is disposed upon the profiled faces.

As will be realized by those of skill in the art, many different embodiments of a gasket according to the present invention are possible. Additional uses, objects, advantages, and novel features of the invention are set forth in the detailed description that follows and will become more apparent to those skilled in the art upon examination of the following or by practice of the invention.

Thus, there has been outlined, rather broadly, the more important features of the invention in order that the detailed description that follows may be better understood and in order that the present contribution to the art may be better appreciated. There are, obviously, additional features of the invention that will be described hereinafter and which will form the subject matter of the claims appended hereto. In this respect, before explaining several embodiments of the invention in detail, it is to be understood that the invention is not limited in its application to the details and construction and to the arrangement of the components set forth in the following description or illustrated in the drawings. The invention is capable of other embodiments and of being practiced and carried out in various ways.

It is also to be understood that the phraseology and terminology herein are for the purposes of description and should not be regarded as limiting in any respect. Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

So that the manner in which the above-recited features, advantages and objects of the invention, as well as others which will become more apparent, are obtained and can be understood in detail, a more particular description of the invention briefly summarized above may be had by reference to the embodiment thereof which is illustrated in the appended drawings, which drawings form a part of the specification and wherein like characters of reference designate like parts throughout the several views. It is to be noted, however, that the appended drawings illustrate only preferred and alternative embodiments of the invention and are, therefore, not to be considered limiting of its scope, as the invention may admit to additional equally effective embodiments.

### BRIEF DESCRIPTION OF THE DRAWINGS

FIG. 1 is a face view of a gasket in an embodiment of the present invention.

FIG. 2 is a cross-sectional view of the gasket core of FIG. 1 taken along line I-I with the gasketing material applied in an embodiment of the present invention.

FIG. 3 is a cross-sectional view of the gasket of FIG. 2, illustrating the core material without the gasketing material applied in an embodiment of the present invention.

FIG. 4 is a cross-sectional view of the profiled portion of the gasket core in an embodiment of the present invention.

### DETAILED DESCRIPTION

Referring now to the figures illustrating a preferred embodiment of the present invention, a gasket assembly 10 is provided for sealing non-round openings, which overcomes the disadvantages of the prior art. In a first aspect of the present invention, the gasket assembly 10 comprises a substantially flat gasket core 20 with sealing material 28 positioned on opposing faces 26 thereof. The gasket core 20 comprises a rigid annular body having an inner periphery 22 defining an aperture and an outer periphery 24 defining the radially outer edge of the gasket. The two gasket faces 26 lie on opposing sides of the gasket core between these inner and outer radial edges.

The gasket assembly further comprises alignment means to ensure proper alignment of the gasket between the two surfaces to be sealed, and support means to retain the gasket in an appropriate position during installation and compression. Additionally, the subject gasket is preferably constructed such that the substrate comprises a single piece of material with no joining methods used to create its non-round shape.

In one embodiment of the present invention, the gasket core comprises any suitable material that would provide structural rigidity as well as any necessary chemical or temperature resistance. The selection of the core material may depend upon the metallurgy of the flanges (or other surfaces) to be sealed, and the degree of chemical resistance desired from the gasket core.

The core is typically constructed of a metallic material. In a preferred embodiment of the present invention, the core is constructed of stainless steel, such as various grades of stainless steel: 304, 309, 310, 316, 321, 347, 410, 430, and 501 stainless steel. In a most preferred embodiment of the present invention, the gasket core comprises 316L stainless steel. Other suitable core materials provided as a non-limiting illustration include various grades of carbon steel, aluminum, brass, copper, nickel, phosphor bronze, zirconium, tantalum, and titanium, or alloys thereof such as Alloy 20, Hastelloy® B and C, Inconel® 600, Incolloy® 825, Monel®, or other suitable non-metallic materials such as engineering plastics.

The gasket core 20 further comprises two profiled faces that lie between the inner and outer radii of the core. In a preferred embodiment of the present invention, the profiled faces comprise radially spaced alternating peak 32 and groove designs 34 where the path of each peak or groove follows the non-round shape of the gasket. In one embodiment of the present invention, the profiling extends across an entire face of the gasket from the radially inner edge 22 to the radially outer edge 24. In another embodiment of the present invention, the profiling covers only a portion comprising less than 100% of the gasket face, leaving a portion of the gasket face non-profiled 36, i.e. substantially smooth.

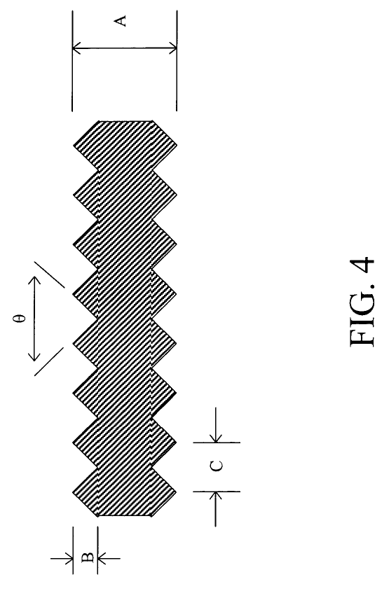

The geometry of the profiled faces may come in many forms. In a preferred embodiment of the present invention, the profiled faces comprise a multitude of “serrations”, grooves, or alternating peaks 32 and grooves 34 cut into the surface of the core material 20. The peaks and grooves form a “V inverted-V” pattern with sharp peaks and likewise sharp grooves. In a preferred embodiment of the present invention, illustrated in FIG. 4 the peaks and grooves form an angle θ of 90°. However, in an alternate embodiment of the present invention, the profile may comprise larger or smaller peaks, defined by larger or smaller angles, or may be a plurality of “U-inverted U” shapes, or other similar shapes or combinations thereof.

In an alternate embodiment of the present invention, the peak and groove pattern comprises one spiral groove cut into the gasket face beginning at a radially inward point on the gasket face and spiraling in an ever increasing radius to a radially outward point on the gasket face.

The profiled core is surrounded by a sealing element comprising a gasketing material. Generally, the gasketing material comprises a material of greater ductility that the flange surfaces or the gasket core that is able to withstand deformative pressure without breaking. In one embodiment of the present invention, the gasketing material comprises any application suitable gasket material, including: elastomer bound fiber gasket material, homogeneous PTFE materials, as well as filled PTFE materials.

In a preferred embodiment of the present invention, the gasketing material comprises expanded graphite. The graphite material is typically an expanded graphite, preferably a nuclear grade, at least about 95% pure graphite (carbon), having no binders or resins, and having less than 50 parts per million leachable chloride and/or fluoride content. In one embodiment of the present invention, the graphite material is a flexible expanded graphite material, sold under the names Grafoil®, Sigraflex®, Flexicarb® or Calgraph®. In alternate embodiments of the present invention, the sealing element may comprise ductile materials such as aluminum, copper or silver.

In another embodiment of the present invention, the gasketing material comprises a chemically resistant polymer material such as a fluorocarbon polymer, preferably polytetrafluoroethylene (PTFE). In one embodiment of the present invention, the gasketing material is a fluorocarbon polymer which is adhesively affixed to a Mylar material having a double-sided coating of pressure sensitive adhesive material. Fluorocarbon polymers are characterized by their thermoplastic properties, resistance to chemicals, moisture, solvents, and oxidation, non-combustibility, and broad useful temperature range (i.e., up to 316° C.). The structure of fluorocarbon polymers comprises a straight back-bone of carbon atoms symmetrically surrounded by fluorine atoms.

Expanded fluorocarbon polymers such as polytetrafluoroethylene (PTFE), polyvinylidene fluoride, hexafluoropropylene, fluorinated ethylene-propylene polymers, and chlorotrifluoroethylene polymers are preferred because of their resilience, chemical resistance, low torque sealing, and limited cold flow or creep. These expanded fluorocarbon polymers may be sold under the names Teflon®, Halon®, Viton®, Gylong, Intertex®, and Gore-Tex®. The characteristic of limited cold flow is particularly desirable in a gasket used in conditions where the seating stress of a flange may diminish over time.

In a preferred embodiment of the present invention, the gasketing material is adhered to the gasket core with a spray adhesive, such as the spray adhesive Super 77™ sold by the 3M Corporation. In another embodiment of the present invention, the gasketing material is adhesively affixed to a Mylar material having a double-sided coating of a pressure sensitive adhesive material. The gasketing material preferably extends beyond at least one edge of the gasket core to partially encapsulate the gasket core in the gasketing material. Further, the gasketing material is typically applied as a sheath having a thickness sufficient to coat the profiled face of the core.

In a still further embodiment of the present invention, other gasketing materials may be employed. The selection of the gasketing material may depend upon the chemical composition of fluids (i.e., liquids and/or gases, with or without solids) which may contact the gasket, and the temperature, pressure, or other operating conditions to which the gasket may be exposed. However, materials which are both resilient and chemically resistant are preferred.

In another embodiment of the present invention, the gasket assembly comprises at least one tab 30 which functions to secure the gasket against the sealing surface as well as aid in maintaining gasket location during installation. The at least one tab 30 protrudes from the outer periphery 24 of the gasket defining an orientation for the gasket. Gasket orientation, determined through the location and orientation of the tab, is used during installation to confirm that the gasket is oriented correctly about the flange and/or over the aperture to be sealed. In a preferred embodiment of the present invention, the at least one tab comprises four tabs spaced at predetermined intervals along the edge.

For example, in an embodiment of the present invention wherein the gasket assembly is employed to seal a manway in a large tank or vessel, the gasket assembly is first positioned about the manway door. Then the tab or tabs are bent around the manway door thereby physically attaching the gasket assembly to the door. When the door is closed, the gasket assembly will remain in position relative to the door, thereby effecting a seal between the manway door and the side of the vessel. The tab or tabs keep the gasket assembly from shifting while the door is being closed and secured to the vessel.

In a preferred embodiment of the present invention, the installation aiding tabs are shaped in a hooking or squared off “U” shape and fastened to the substrate by welding. This maintains close proximity of the gasket to the sealing faces of the door or cover. The tabs that are attached to the substrate can be any number of geometric shapes or a combination of shapes that achieve the purposes of holding the gasket against the sealing face of the door or cover.

In one embodiment of the present invention, the tabs are fabricated from a ductile material which is welded to the gasket core. In a preferred embodiment of the present invention, the tab material is selected from a material, such as a thin gauge metal or other ductile material, which can be bent without the use of tools or machinery. In alternate embodiments of the present invention, the tabs may be constructed of the gasket core material, or the gasket sealing material.

In a further embodiment of the present invention, the inner periphery is designed such that it is slightly larger than the opening to be sealed. This small difference prevents the gasket from being crimped on the inner diameter of the manway door.

### EXAMPLE

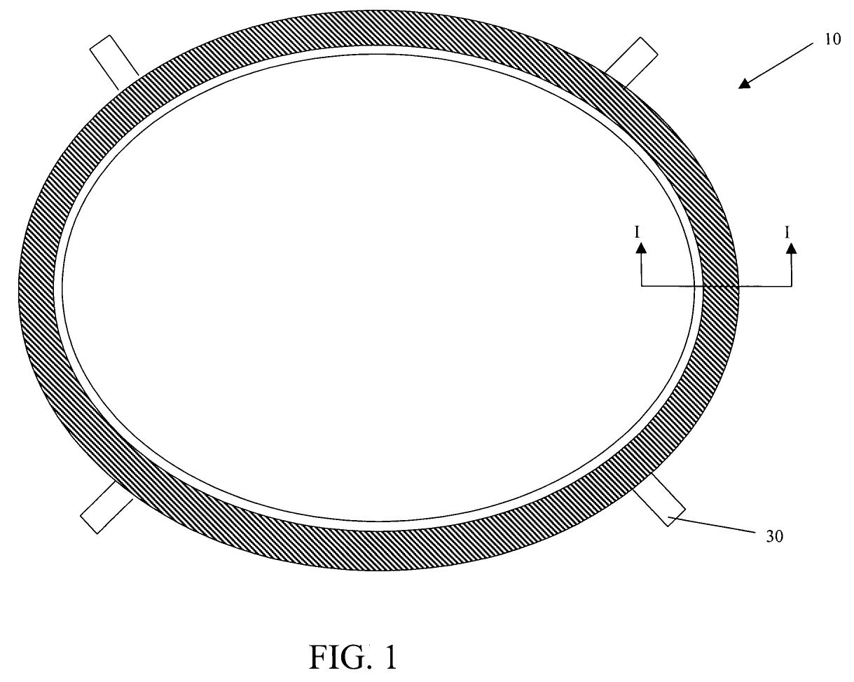

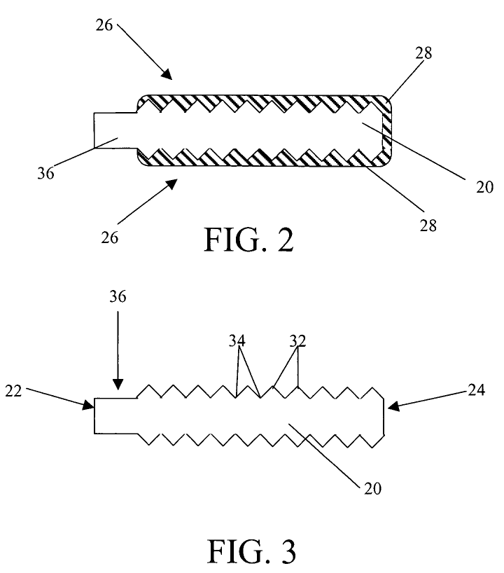

In one embodiment of the present invention, a non-round gasket assembly, in this example oval, with profiled surface and installation aids was manufactured in accordance with the following method. This gasket assembly is shown in FIGS. 1 and 4.

(1) A ⅛-inch thick 316L stainless steel plate was cut to a rectangle having long sides of 17 inches and short sides of 13 inches.

(2) The rectangle of ⅛-inch steel was then center punched.

(3) The rectangle was then circle-sheared to cut out an oval having a radially outer edge defining a major axis of 17 14/16 and a minor axis of 13 14/16.

(4) The ⅛-inch thick oval was then profiled to cut 30/1000-inch deep grooves (B) in both faces of the gasket core having a peak to peak width (C) of 60/1000 inches and a peak and groove angle θ of 90° resulting in approximately 16 ⅔ grooves/inch across the face of the gasket core. The grooves are preferably designed to form a plurality of concentric, parallel, oval rings defined by the ridges, peaks, or apexes and the hollows, troughs, or valleys, which, in the case of a pipeline flange gasket, are concentric with the circumferential inner border and outer border of the gasket core.

(5) The profiled ⅛ inch thick gasket core was again circle-sheared to cut out an inner aperture a major axis of 16 inches and a minor axis of 12 inches, leaving a 15/16 inch profiled gasket face.

(6) The oval gasket core was then provided with stainless steel tabs measuring 1 inch long by ½ inch wide and 24/1000 inch think. The tabs were welded to the exterior of the metal core at predetermined points along the outer edge.

(7) Expanded graphite sheet material (e.g., the 0.020 inch thick Calgraph® or Flexicarb® expanded graphite sheet) was obtained, and a pressure sensitive double-sided adhesive (having Mylar backing, 0.002 inch thick) was applied to the expanded graphite material. The double-sided adhesive typically is available in sheets containing quick-release, peel-off layers on both sides to protect the adhesive until use.

(8) The expanded graphite/adhesive composite was then die stamp cut with a Rule Steel die having the desired dimensions (here, an outer major axis of 17 14/16 inches and minor axis of 13 14/16 inches, and a width of approximately 15/16 inches) to create two matching oval ring-shaped graphite/adhesive laminates.

(9) The profiled metal core was then encapsulated from the outer edge to the inner most peak or valley with the expanded graphite by laminating and molding both sides of the core material with the laminate layers of 0.022-inch thick adhesive-backed expanded graphite. A first oval ring-shaped laminate layer was symmetrically and proportionally aligned with the metal core. Sufficient pressure was applied to the first laminate layer to adhere it to the core and to maintain such alignment with the core until the second laminate layer was applied. The second laminate layer was applied in similar fashion to the opposite face of the metal core.

(10) The laminated gasket was then placed between two foam/cloth padded rollers. Compression was applied to the rollers, and the gasket was rotated around the rollers in circular fashion to mold and compress the adhesive-backed graphite laminates into the individual corrugations (i.e., the area defined by the ridges, peaks, or apexes and the hollows, troughs, or valleys), such that the graphite layers adhere to the core.

(11) As an additional step to the above-described method, it may be desirable to apply heat to the gasket surface sufficient to carbonize the Mylar or other suitable backing of the expanded graphite layers.

Although the present invention has been described with reference to particular embodiments, it should be recognized that these embodiments are merely illustrative of the principles of the present invention. Those of ordinary skill in the art will appreciate that the apparatus and methods of the present invention may be constructed and implemented in other ways and embodiments. Accordingly, the description herein should not be read as limiting the present invention, as other embodiments also fall within the scope of the present invention.

1. A gasket assembly comprising:
an annular gasket core having two faces and defining an aperture therethrough, wherein at least one of the two faces has a profiled configuration along at least a portion of said face;
at least one installation tab secured to an outer periphery of said gasket core; and
gasketing material disposed upon the at least one profiled face.

2. The gasket assembly of claim 1, wherein both faces are profiled.

3. The gasket assembly of claim 1, wherein said profiling comprises a series of radially spaced concentric peaks separated by grooves formed into the core material.

4. The gasket assembly of claim 1, wherein said profiling extends across less than the entire face of the gasket core.

5. The gasket assembly of claim 4, wherein said gasketing material is disposed upon a portion of the gasket core face coextensive with said profiling.

6. The gasket assembly of claim 1, wherein said profiling extends across the entire radially face of the gasket core.

7. The gasket assembly of claim 1, wherein said at least one installation tab comprises a bendable material.

8. The gasket assembly of claim 1, wherein said at least one installation tab is welded to the gasket core.

9. The gasket assembly of claim 1, wherein said at least one installation tab comprises four installation tabs.

10. The gasket of claim 1, wherein said gasketing material comprises expanded graphite.

11. The gasket of claim 1, wherein said gasketing material comprises a fluorocarbon polymer.

12. The gasket of claim 1, wherein said gasketing material comprises a fluorocarbon polymer with a graphite filler.

13. The gasket of claim 1, wherein said gasketing material is adhered to the gasket face with an adhesive.

14. The gasket of claim 12, wherein said adhesive comprises a spray adhesive.

15. The gasket of claim 12, wherein said adhesive comprises a pressure sensitive adhesive.

16. A gasket assembly comprising:
a substantially flat annular gasket core having two profiled faces and defining an aperture therethrough, said profiled faces comprising an alternating peak and groove configuration defined by angles of approximately 90°, and at least one installation tab secured to an outer periphery of said gasket core; wherein said gasket core comprises a metallic material and gasketing material is disposed upon the profiled faces.

17. A gasket assembly comprising:
a substantially flat annular stainless steel gasket core having two partially profiled faces and defining an aperture therethrough, said partially profiled faces comprising a radially spaced alternating peak and groove configuration defined by peak angles of approximately 90°, and four installation tabs secured to an outer periphery of said gasket core formed of a ductile material; wherein said gasket core comprises a gasketing material is disposed upon the profiled faces.
